(19) United States
(12) Patent Application Publication
(10) Pub. No.: US 2026/0127957 A1
(43) Pub. Date: May 7, 2026

(54) LEVERAGING A LARGE LANGUAGE MODEL FOR UNIVERSAL DISPATCH MESSAGING

(71) Applicant: Tango Tango, Inc., Huntsville, AL (US)

(72) Inventors: Richard Walker, Huntsville, AL (US); Thomas Alva Sharp, III, Huntsville, AL (US); Beck Everett Mitchell, Madison, AL (US); James Andrew Ballance, Huntsville, AL (US)

(21) Appl. No.: 18/938,112

(22) Filed: Nov. 5, 2024

(51) Int. Cl. G08B 25/01; G06F 40/103

(52) U.S. Cl. CPC G08B 25/016; G06F 40/103

(57) ABSTRACT

Embodiments of leveraging a large language model (LLM) for universal dispatch messaging is described. A computer aided dispatch (CAD) message describing an event is received from a dispatch service of a plurality of dispatch services. The CAD message is in a first format, and at least some of the plurality of dispatch services generate CAD messages that are in a different format. The LLM is prompted to generate a structured message from the CAD message. The LLM may be prompted, based in part on the CAD message, to generate announcement text. An event record is stored that includes the structured message and may also include the announcement text. User devices are identified that are associated with users based in part on content of the structured message. Alerts are provided of the event to the user devices based in part on the structured message and user preferences of the users.

### FIELD OF THE INVENTION

The disclosure relates generally to computer aided dispatch, and more specifically to leveraging a large language model for universal dispatch messaging.

### BACKGROUND

Many entities (e.g., fire departments, police departments, government agencies, etc.) receive notification of events via their own respective dispatch service. These notifications may also dispatch units (e.g., ambulance, fire truck, etc.) to handle the events. Each dispatch service generally reports events that are material (e.g., within a region of responsibility of an entity) to its entity(ies) via computer aided dispatch (CAD) messages. However, different dispatch services generally are closed systems that generate CAD messages in different formats and have different means of presentation. Moreover, the ability to receive CAD messages is often limited by the computing platform in which they are hosted (e.g., a WINDOWS system), and CAD messages are designed to be consumed by clients using a particular platform (e.g., WINDOWS system). For example, a first application is used to view CAD messages from a first dispatch service and a second application is used to view CAD messages from a second dispatch service. But, as the first CAD messages have a different format than the second CAD application, generally the second application cannot be used to view CAD messages from the first dispatch service, and vice versa. As such, a user wanting to access messages from different dispatch services may have to use a different means for each dispatch service. This can be particularly problematic when users of a particular entity need to have access to CAD messages coming from a dispatch service of another entity.

Conventionally, there are messaging forwarding systems that an entity can use to make their messages available to other types of clients used by their users. These message forwarding systems generally maintain separate, strict parsers for each possible CAD input format. However, there are many (e.g., hundreds) different formats for CAD messages and input formats generally vary across all CAD users. Accordingly, it is very labor intensive for message forwarding systems to keep parsers up to date for each possible format. Moreover, because of this, message forwarding systems tend to produce erroneous messages responsive to receiving CAD messages in unexpected (e.g., a variation on an existing format or a new format) formats.

### SUMMARY

In accordance with one or more aspects of the disclosure, leveraging a large language for universal dispatch messaging is described. A universal dispatch system receives computer aided dispatch (CAD) messages from a plurality of dispatch services (e.g., associated with different entities). Some or all of the received CAD messages are in different formats from each other. Responsive to receiving a CAD message describing an event, the universal dispatch system uses the large language model to generate a structured message. The structured message organizes information from the CAD message in a standardized structured form. For example, the structured message may be in a JavaScript Object Notation (JSON) format, an extensible markup language (XML) format, yet another markup language (YAML) format, etc. The universal dispatch system may also use the large language model to generate announcement text using the structured message and/or the CAD message. The universal dispatch system may store (e.g., in a data store) an event record that includes the structured message and the announcement text in a data store. The universal dispatch system identifies user devices that are associated with users for notification based in part on content of the structured message. The universal dispatch system provides alerts of the event to the user devices based in part on the structured message and user preferences for the users.

In the above manner, a user device can receive information about the event from the universal dispatch system, even though it is part of an entity that is not associated with the dispatch service. Moreover, the universal dispatch system may be used in lieu of or in addition to the dispatch service to provide information (alerts) to user devices of users that are to respond (or have responded) to the event. The universal dispatch system also uses a large language model to generate structured messages from CAD messages instead of parsers for each possible CAD message format. Additionally, to the extent a new CAD message format may result in inaccuracies in the structured message (or announcement text), prompts to the large language model may be easily modified to handle the new format (versus having to build a new parser, and then maintain the parser going forward).

### BRIEF DESCRIPTION OF THE DRAWINGS

FIG. 1 illustrates an example system environment for a universal dispatch system, in accordance with one or more embodiments.

FIG. 2 illustrates an example system architecture for a universal dispatch system, in accordance with some embodiments.

FIGS. 3A-3B form an example sequence diagram that describes leveraging a large language model for universal dispatch messaging, in accordance with some embodiments.

FIG. 4A illustrates an example user interface associated with an entity, in accordance with some embodiments.

FIG. 4B illustrates an example user interface presenting details of an alert, in accordance with some embodiments.

FIG. 5 is a flowchart for a method of leveraging a large language model for universal dispatch messaging, in accordance with some embodiments.

FIG. 6 is an example flow for using few-shot training with one or more large language models, in accordance with some embodiments.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

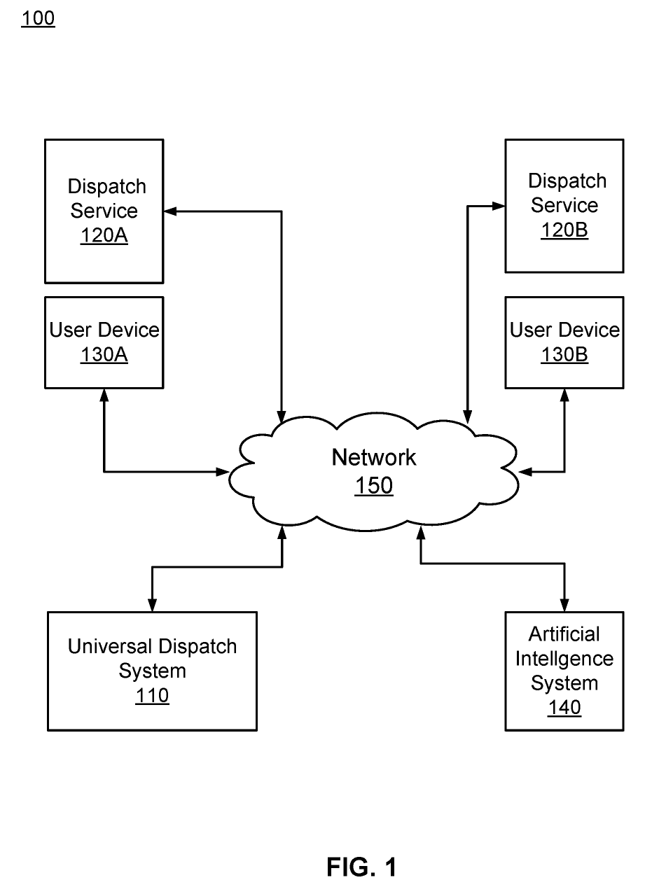

FIG. 1 illustrates an example system environment 100 for a universal dispatch system 110, in accordance with one or more embodiments. The system environment 100 includes a plurality of dispatch services (e.g., dispatch service 120A, dispatch service 120B), a plurality of user devices (e.g., user device 130A, user device 130B), an artificial intelligence (AI) system 140, and the universal dispatch system 110 coupled by a network 150. Alternative embodiments may include more, fewer, or different components from those illustrated in FIG. 1, and the functionality of each component may be divided between the components differently from the description below. As such, there may be more than one dispatch service, user device, AI system 140, network 150, etc. Moreover, in some embodiments, the universal dispatch system 110 may include the functionality of the AI system 140. Additionally, each component may perform their respective functionalities in response to a request from a human, or automatically without human intervention.

An entity is an organization that responds to events in accordance with its mission. Entities are often a public safety organization (e.g., fire department, police department, etc.) and/or some form of government agency. As such, an event may be a medical incident, a reported crime, a traffic accident, a city infrastructure problem (e.g., flooding, downed power line, etc.), some other type of incident that is material to an entity, etc. Note that entities may have different mandates and/or areas of operation. For example, a fire department for a city (e.g., Beverly Hills), generally does not operate outside of the city. But, in some cases, separate entities may have to work together. For example, a large structure fire in Beverley Hills may have personnel from the Beverly Hills Fire Department (one entity) as well as the Los Angeles County Fire Department (a different entity). Each entity includes one or more users who are associated with one or more user devices.

The plurality of dispatch services report events to the universal dispatch system 110, and in some embodiments, also report events to user devices of associated entities. Each of the plurality of dispatch services are associated with at least one respective entity. For example, the dispatch service 120A may be associated with a first entity (e.g., city police department) that includes a user associated with the user device 130A, and the dispatch service 120B may be associated with a second entity (e.g., county fire department) that includes a user associated with the user device 130B. In response to an event being reported to a dispatch service, the dispatch service may identify units of an entity to be dispatched to a location of the event. The dispatch service may then generate a computer aided dispatch (CAD) message that describes the event. The dispatch service sends the CAD message to the universal dispatch system 110. In some embodiments, the dispatch service also sends the CAD message to one or more user devices of the entity associated with the dispatch service. Note that the dispatch service does not send CAD messages to user devices of entities that are not associated with the dispatch service. For example, the dispatch service 120A may send a CAD message reporting an event to the universal dispatch system 110 and to the user device 130A that is part of the entity associated with the dispatch service 120A, but not to the user device 130B (is associated with a different entity). Likewise, the dispatch service 120B may send a CAD message reporting an event to the universal dispatch system 110 and to the user device 130B that is part of the entity associated with the dispatch service 120B, but not to the user device 130A (is associated with a different entity).

Some or all of the plurality of dispatch services generate CAD messages in different formats from each other. For example, the dispatch service 120A generates CAD messages in a first format that is different from a format of CAD messages generated by the dispatch service 120B. In some embodiments, the CAD messages generated by a dispatch service are unstructured. A CAD message includes information describing an event. The information may include, e.g., a description, a street address associated with the event, a type of call (e.g., medical), information about a patient (e.g., gender, injury, etc.), time of the event, station and/or unit responding to call, incident number, case number, some other, etc. Moreover, different dispatch services may include different information in their CAD messages based in part on their associated entities. Note that a CAD message is generated using reported information. As such, a CAD message often does not include a title, global positioning system (GPS) coordinates for the event, etc., as this information is generally not part of the reported information used to generate the CAD message. Moreover, dispatchers taking reports of events often lack the time and/or training to reliably assign priority levels to CAD messages, as such, CAD messages generally also do not include priority levels.

A user device is a client device through which a user may interact with the universal dispatch system 110. The user device may also be used to interact with one or more dispatch systems via application programming interfaces (APIs) and/or web portals specific to the one or more dispatch systems. A user device may be a radio, a personal or mobile computing device (e.g., such as a smartphone, a tablet, a laptop computer, or desktop computer), or some combination thereof.

The user device presents alerts (e.g., SMS message, email, text, audio) from the universal dispatch system 110 that corresponds to structured messages generated based on CAD messages from one or more dispatch services. In some embodiments, a user device (e.g., the user device 130A, the user device 130B) may present a user interface to the user. The user interface may be, e.g., a web portal of the universal dispatch system 110 and/or part of a client application that uses an API to communicate with the universal dispatch system 110.

In some embodiments, a user may use the user interface to set one or more user preferences for how to receive alerts from the universal dispatch system 110. Moreover, some users associated with a particular entity may have authority to select which user devices of the entity receive alerts from the universal dispatch system 110. In some embodiments, the user may customize alert recipients based in part on content of the alert. For example, a fire truck from Los Angeles County Fire Department deployed to assist a Beverly Hills Fire Department with a structure fire in Beverly Hills would be interested in events relating to the structure fire, but not other unrelated events (unrelated medical call, etc.) that occur in Beverly Hills. As such, a user in Los Angeles County Fire Department may use the user interface to ensure that the units deployed to Beverley Hills receives alerts (that are based on CAD messages from the Beverly Hills dispatch service) that are about the structure fire, and are not sent alerts (that are based on CAD messages from the Beverly Hills dispatch service) that are about unrelated events.

In some embodiments, the user interface may be used to present alerts from the universal dispatch system 110. Note that the received alerts may be based on CAD messages received from dispatch services that are not associated with a same entity as the user device. Moreover, the user interface may be used to receive these alerts. In contrast, conventionally, a user of a user device may have to cycle between different means of viewing (e.g., different client applications) to see CAD messages from different dispatch services.

The AI system 140 may be configured to apply inputs (e.g., prompts) to one or more machine-learning models to generate responses to the prompts. As used herein, machine-learning model is used interchangeably with "large language model." A prompt is an input to a large language model that causes the large language model to generate an output. A prompt may include, e.g., instructions (e.g., convert a CAD message to a JSON format) for the large language model, examples (e.g., CAD messages and corresponding structured messages in a JSON format), contextual information (e.g., official regulations for determining priority level), etc. The AI system 140 includes one or more machine-learning models. The one or more machine-learning models may be generative machine-learning models.

Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network.

The AI system 140 may be configured to generate a structured message from a CAD message that is in a different format. For example, the AI system 140 may receive one or more prompts from the universal dispatch system 110. A prompt may be to generate a structured message from the CAD message in the first format. The AI system 140 may apply the prompt to a large language model to generate the structure message. In some embodiments, the prompt may also instruct the large language model to generate a title for the structured message (e.g., based on the CAD message and/or the structured message). The AI system 140 may provide the generated structured message may to the universal dispatch system 110.

In some embodiments, the prompt (or a subsequent prompt from the universal dispatch system 110) may instruct the large language model to determine a priority level based in part on the structured message. A priority level (e.g., alpha, bravo, etc.) is an indication of importance of an alert to the entity. The large language model may use some or all of one or more official regulations that describe determination of priority levels in the determination of a priority level of the structured message. In some embodiments, the prompt may also instruct the AI system 140 to update the structured message with the priority level prior to providing the structured message to the universal dispatch system 110.

The AI system 140 may be configured to generate announcement text using a structured message and/or the CAD message. Announcement text is a textual description of an event that is based in part on information from the CAD message describing the event and/or derived from the CAD message describing the event (e.g., a structured message). For example, the AI system 140 may receive one or more prompts from the universal dispatch system 110. A prompt may be to generate announcement text using the structured message (e.g., that was previously generated using the large language model). In another embodiment, a prompt may be to generate announcement text using the CAD message. The AI system 140 may apply the prompt to the large language model to generate the announcement text. The generated announcement text may be provided to the universal dispatch system 110.

The plurality of user devices (e.g., the user device 130A and the user device 130B), the dispatch services (e.g., the dispatch service 120A and the dispatch service 120B), the AI system 140, and the universal dispatch system 110 can communicate with each other via the network 150. The network 150 is a collection of computing devices that communicate via wired or wireless connections. The network 150 may include one or more local area networks (LANs) or one or more wide area networks (WANs). The network 150, as referred to herein, is an inclusive term that may refer to any or all of the standard layers used to describe a physical or virtual network, such as the physical layer, the data link layer, the network layer, the transport layer, the session layer, the presentation layer, and the application layer. The network 150 may include physical media for communicating data from one computing device to another computing device, such as multiprotocol label switching (MPLS) lines, fiber optic cables, cellular connections (e.g., 3G, 4G, or 5G spectra), or satellites. The network 150 also may use networking protocols, such as TCP/IP, HTTP, SSH, SMS, or FTP, to transmit data between computing devices. In some embodiments, the network 150 may use Simple Network Paging Protocol (SNPP) protocol to transmit data between computing devices. In some embodiments, the network 150 may include Bluetooth or near-field communication (NFC) technologies or protocols for local communications between computing devices. The network 150 may transmit encrypted or unencrypted data. In some embodiments, the network 150 may include radio transceivers for communicating via radio (e.g., broadcasting alerts to user devices).

The universal dispatch system 110 generates structured messages (e.g., in a JSON format) that correspond to CAD messages received from the plurality of dispatch services. The universal dispatch system 110 receives CAD messages from various dispatch services (e.g., the dispatch service 120A, the dispatch service 120B, etc.). The universal dispatch system 110 generates one or more prompts for application to a large language model (e.g., of the AI system 140). The universal dispatch system 110 may prompt the large language model with the one or more prompts to generate structured messages for the received CAD messages. In some embodiments, the one or more prompts also prompt the large language model to generate titles and/or determine priority levels for the structured messages. In some embodiments, the universal dispatch system 110 also prompts the large language model to generate announcement text for some or all of the generated structured messages. The universal dispatch system 110 may store event records that includes the structured messages (and in some embodiments the announcement text). For each structured message, the universal dispatch system 110 identifies user devices that are associated with users for alert based in part on content of the structured message. The universal dispatch system 110 may generate alerts using the structured messages based in part on user preferences of the users associated with the identified user devices. For example, user preferences for a user may indicate alerts to be sent via email, whereas user preferences for a different user may indicate alerts to be sent via radio. The universal dispatch system 110 may provide the alerts via the network 150 to the identified user devices. For alerts sent via radio, the universal dispatch system 110 may apply a text-to-speech converter on announcement text associated with alert to generate audio data, and broadcast the audio data. In some embodiments, the universal dispatch system 110 may use a third party alert service to provide alerts to the identified user devices.

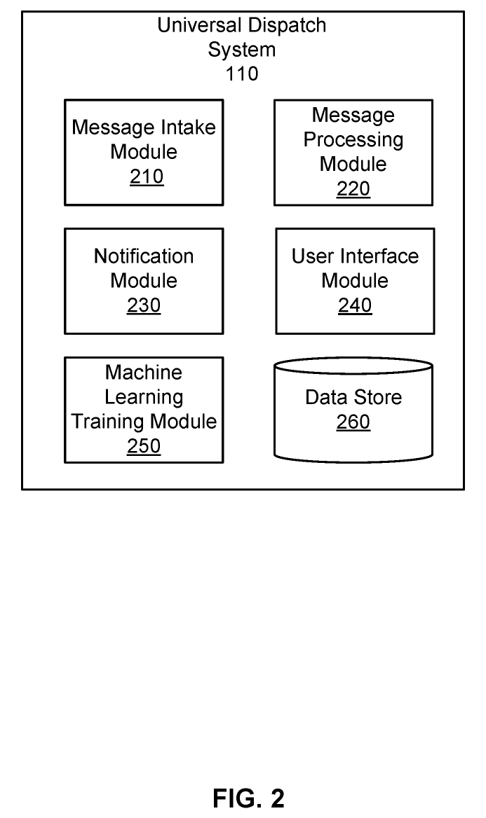

FIG. 2 illustrates an example system architecture for a universal dispatch system 110, in accordance with some embodiments. The system architecture illustrated in FIG. 2 includes a message intake module 210, a message processing module 220, a notification module 230, a user interface module 240, a machine-learning training module 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The message intake module 210 receives CAD messages from various dispatch services. The received CAD messages may have different formats based on which dispatch service sent them. The message intake module 210 may receive CAD messages from dispatch services via the network 150. The message intake module 210 may include one or more servers (e.g., email server, SNPP server, web server, etc.) to intake the CAD messages from the network 150.

For a received CAD message from a dispatch service, the message intake module 210 may validate that the CAD message was actually provided by the dispatch service. For example, the message intake module 210 retrieves an identifier (e.g., email domain, code, etc.) from the data store 260. The message intake module 210 may then compare the identifier to a corresponding identifier of the received CAD message. Based on the comparison, the message intake module 210 may determine whether or not that the CAD message was provided by the dispatch service. In some embodiments, the message intake module 210 may use two-factor authentication or some other means to authenticate a source of the received CAD message. In some embodiments, an incoming CAD message may contain a specific sequence of characters. The message intake module 210 may screen the received CAD message for the sequence of characters, and if not present, reject the CAD message.

A structured message organizes information from a CAD message in a standardized structured form. A structured message includes a plurality of fields that can be populated with information from (e.g., address) and/or information derived (e.g., title, priority level, geographic coordinates, etc.) from a CAD message. The plurality of fields may include, e.g., one or more location fields (e.g., an address field, a city field, etc.), a call type field (describes a type of event, e.g., medical, fire, etc.), a code field ( provides a terse specific representation of the call (e.g., "motor vehicle accident, 2 vehicles involved," may have a code field of "MVA2I")), an incident number (ID) field (identifier associated with the CAD message), an info field (provides a description of the event), a unit field (identifies units dispatched for the event), a title field, one or more geographic coordinates field (e.g., GPS coordinates for the address), a priority level field, some other field relevant to an entity, or some combination thereof. Note that in some embodiments, the fields may differ from those above.

The message processing module 220 converts CAD messages to structured messages. The message processing module 220 may generate one or more prompts for application to a large language model (e.g., of the AI system 140 and/or of the universal dispatch system 110). The message processing module 220 may prompt the large language model with the one or more prompts to generate structured messages for the received CAD messages. The structured messages have a standardized, structured format that is different from the format of the received CAD messages. The structured format may be, e.g., a JSON format, an XML format, a YAML format, etc.

The one or more prompts may also prompt the large language model to generate titles for the structured messages. A title provides a high level description of the structured message. A prompt to generate a title may include instructions to generate the title based on specific fields of the structured message and/or the CAD message. For example, the prompt may instruct the large language model to generate a title for a structured message based on, e.g., a call type (e.g., medical), information field (e.g., "Chief Complaint: Head injury, bleeding badly. Patient: 25 year old male. Case Number: 2024-03582"), and address field ("230 Main St) of a structured message, resulting in the title being "Medical: Bleeding from head at 230 Main Street."

The one or more prompts may also prompt the large language model to determine priority levels for the structured messages. A priority level is an indication of importance of an alert to the entity. For example, for some fire codes, there are five priority levels, specifically, Alpha, Bravo, Charlie, Delta, and Echo, ranked in order of severity with Echo being the most severe. The message processing module 220 may also provide, for use in determination of a priority level of a structured message, to the large language model one or more official regulations (e.g., "The Principles of Emergency Medical Dispatch," 3rd Edition by J. Clawson and K. Dernocoeur, 2001, etc.)) that describe how to determine priority levels.

The message processing module 220 may also prompt the large language model to generate announcement text based in part on the CAD messages. Announcement text is a textual description of an event that is based in part on information from the CAD message describing the event and/or derived from the CAD message describing the event (e.g., a structured message). For example, announcement text may be a readable form of the structured message that includes one or more sentences. In some embodiments, acronyms and/or abbreviations in the structured message or CAD message are replaced with their expanded form in the announcement text. In some embodiments, the message processing module 220 may prompt the large language model to generate announcement text based on structured messages (e.g., ones generated by the large language model). In some embodiments, the message processing module 220 may prompt the large language model to generate announcement text directly from CAD messages. Generating announcement text using a CAD message may be done in parallel with or in series with using the large language model to generate the structured message from the CAD message. The message processing module 220 may apply the announcement text to a text-to-speech converter to generate corresponding audio data (e.g., that can be played back by a user device, played and broadcast as a radio signal, etc.).

In some embodiments, the message processing module 220 may determine geographic coordinates for a location described in the structured message. Geographic coordinates describe a geographic point. Geographic coordinates may include, e.g., GPS coordinates, latitude-longitude coordinates, WHAT3WORDS coordinates, etc. The message processing module 220 may extract a street address from the structured message. The message processing module 220 may convert the street address to the geographic coordinates, and update the structured message with the geographic coordinates. In some embodiments, the message processing module 220 may convert the street address to geographic coordinates using, e.g., a third party look up service.

The message processing module 220 stores event records associated with the received CAD messages in the data store 260. An event record includes a structured message generated from a CAD message, and may also include announcement text for the structured message, audio data corresponding to the announcement text, the CAD message, or some combination thereof. In some embodiments, an event record may also include other data (e.g., feedback from a user about the structured message).

In some embodiments, the message processing module 220 may determine that a CAD message is an update to a previously received CAD message using an ID value (e.g., incident number) in the structured message. The message processing module 220 may link an event record of the CAD message to an event record associated with a structured message generated from the previously received CAD message. The message processing module 220 may update the structured message (and/or a generated alert for the structured message) to show that it is an update to the structured message generated from the previously received CAD message.

The notification module 230 identifies user devices that are associated with users for notification of alerts based in part on content of structured messages. The notification module 230 may, e.g., retrieve a distribution look up table (LUT) from the data store 260. The distribution LUT maps CAD messages from particular dispatch services to a corresponding set of user devices that are part of one or more entities. The notification module 230 may use the distribution LUT to determine which user devices to send alerts. An alert reports information that is based on content of the structured message. In some cases, the alert may report some or all of the structured message, announcement text, audio data, or some combination thereof. An alert may be sent via, e.g., email, SMS, SNPP, radio, mobile application, etc. The notification module 230 generates alerts for user devices based in part on user preferences of users associated with the identified user devices. The notification module 230 then sends the generated alerts to the identified user devices.

The user interface module 240 manages user interfaces for one or more user devices. A user interface may be used by a user of a user device to interact with the universal dispatch system 110. The user interface may be, e.g., a web portal, and/or a client application that uses an API to communicate with the universal dispatch system 110. The user interface may be used to set user preferences for how (e.g., email, radio, SMS, etc.) alerts are to be provided to users of the user devices. In some embodiments, the user interface may also be used to customize alert recipients based in part on content of the alert. For example, the user interface may allow a user to filter notification of alerts to users based in part on content of one or more fields of a structured message. In some embodiments, the user interface module 240 may receive a request from a user device of a first entity to receive alerts from a dispatch service of a second entity. In some embodiments, the user interface module 240 may confirm that the second entity has authorized the first entity to receive their alerts before fulfilling the request.

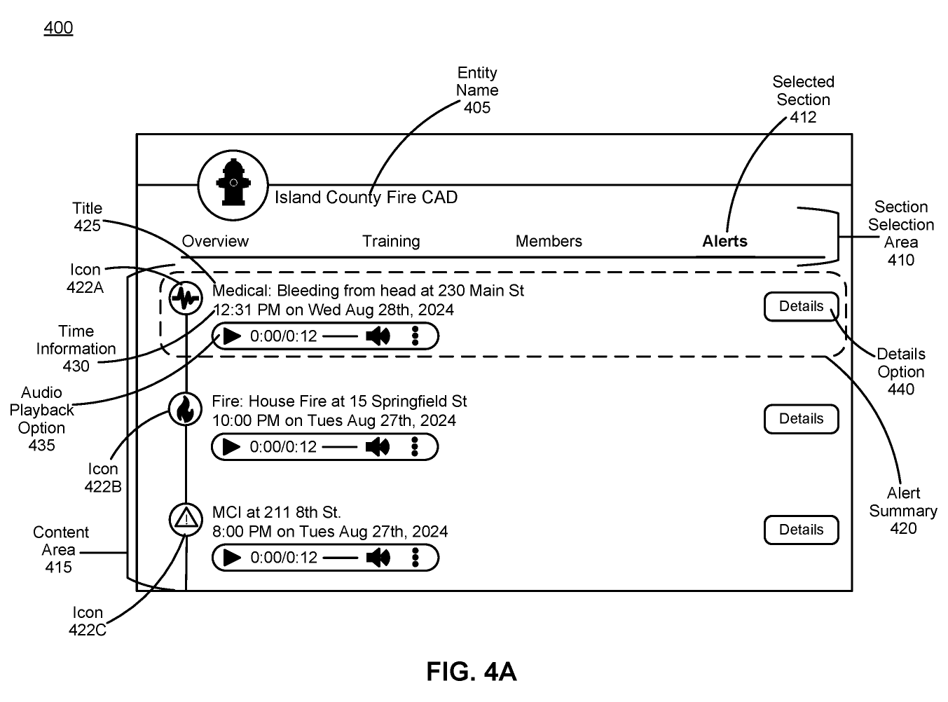

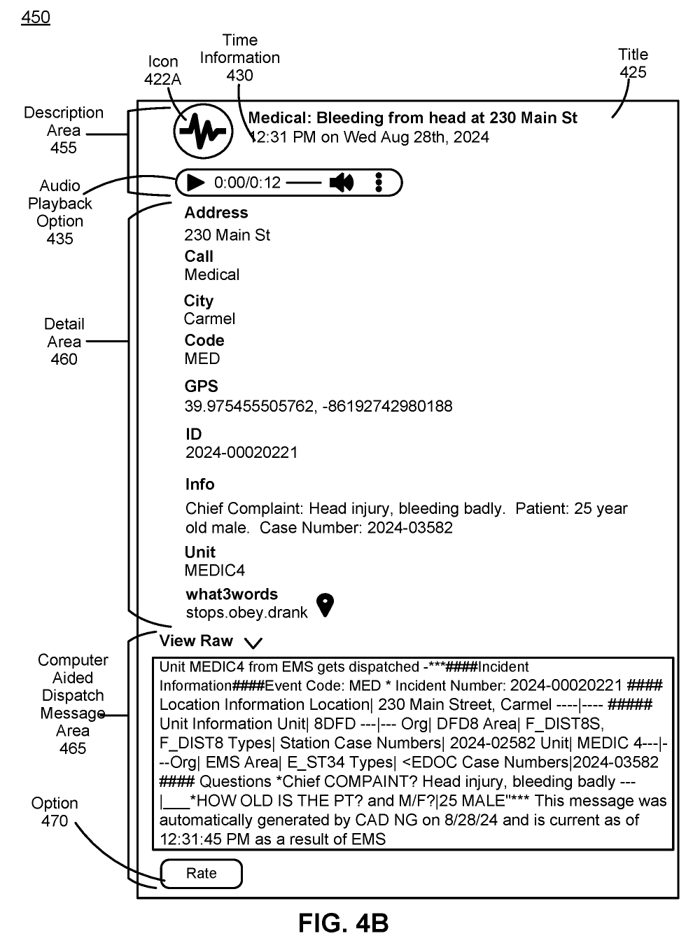

The user interface may present one or more alert summaries of alerts that were previously provided to the user device(s) associated with a user. An alert summary is a high level description of an alert. An alert summary may include, e.g., a title, timing information (e.g., time of the alert), and audio playback option for audio data corresponding to announcement text of the alert, etc. An example of a user interface presenting alert summaries is described below with regard to FIG. 4A.

In some embodiments, the alert summaries are selectable, such that, responsive to a selection of an alert summary of an alert, the user interface module 240 retrieves an event record associated with the alert. The user interface module 240 may update the user interface with details from the event record. The details may include, e.g., some or all of the structured message, announcement text for the structured message, audio data for the announcement text, a CAD message used to generate the structured message, etc.

The user interface may also include an option to provide feedback on an alert. In this manner, a user may compare an alert that was sent out by the universal dispatch system 110 to the corresponding CAD message, and provide feedback regarding the alert. In some embodiments, the option to provide feedback may be in the form of saving the event record associated with the detail view as a training example. In some embodiments, the option to provide feedback may include, e.g., providing a window and/or rating system through which the user can provide comments on the alert and/or rate the alert. An example of a user interface presenting details of a previously provided alert is described below with regard to FIG. 4B.

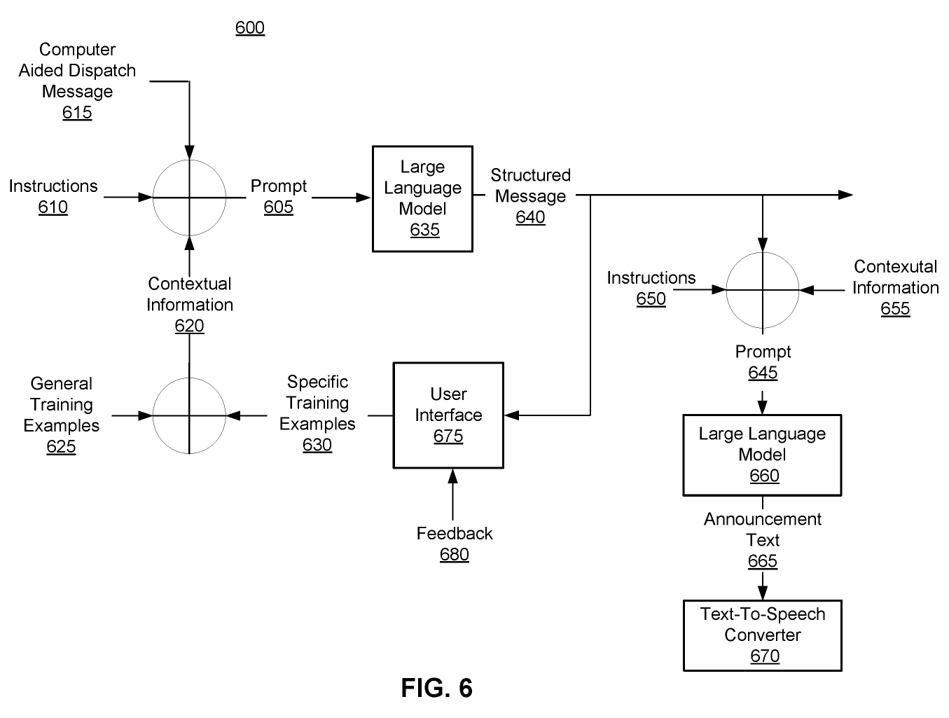

The machine-learning training module 250 may use few-shot training techniques to generate prompts that can be applied to one or more large language models (e.g., of the AI system 140 and/or of the universal dispatch system 110). For example, few-shot training techniques may be used to generate a prompt to generate a structured message from a CAD message of a particular format, generate a prompt to generate announcement text using the structured message, generate a prompt to generate announcement text using the CAD message, generate a prompt to generate a title for the structured message, generate a prompt to determine a priority level of the structured message, or some combination thereof. A generated prompt may include, e.g., instructions, a CAD message, and contextual information. The instructions may instruct the large language model to convert the CAD message to the structured message. The instructions may include, e.g., a schema for a format of the structured message (e.g., a schema for JSON). The contextual information provides examples of CAD messages and their corresponding structured messages. The examples may be based on, e.g., real world CAD messages and corresponding structured messages that have been approved (e.g., by a user associate with an entity and/or an administrator of the universal dispatch system 110 for use in generating better prompts. An example of few-shot training is described below with regard to FIG. 6.

In some embodiments, the machine-learning training module 250 may train one or more machine learning models used by the universal dispatch system 110. The machine-learning training module 250 trains a machine-learning model based on a set of training examples. Each training example includes input data to which the machine-learning model is applied to generate an output. For example, each training example may include a CAD message, a corresponding structured message, corresponding announcement text, corresponding audio data, a title of the structured message, a priority level of the structured message, or some combination thereof. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 250 may apply an iterative process to train a machine-learning model whereby the machine-learning training module 250 updates parameter values of the machine-learning model based on each of the set of training examples. The training examples may be processed together, individually, or in batches. To train a machine-learning model based on a training example, the machine-learning training module 250 applies the machine-learning model to the input data in the training example to generate an output based on a current set of parameter values. The machine-learning training module 250 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 250 updates the set of parameters for the machine-learning model based on the score generated by the loss function. For example, the machine-learning training module 250 may apply gradient descent to update the set of parameters.

In some embodiments, the machine-learning training module 250 may retrain the machine-learning model based on the actual performance of the model after the universal dispatch system 110 has deployed the model to provide service to users. For example, if the machine-learning model is used to predict a likelihood of an outcome of an event, the universal dispatch system 110 may log the prediction and an observation of the actual outcome of the event. Alternatively, if the machine-learning model is used to classify an object, the universal dispatch system 110 may log the classification as well as a label indicating a correct classification of the object (e.g., following a human labeler or other inferred indication of the correct classification). After sufficient additional training data has been acquired, the machine-learning training module 250 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the universal dispatch system 110 as a whole in its performance of the tasks described herein.

The data store 260 stores data used by the universal dispatch system 110. For example, the data store 260 stores CAD messages, alerts, event records, user preferences for use by the universal dispatch system 110, one or more distribution LUTs, some other information used by the universal dispatch system 110, or some combination thereof. The data store 260 also stores trained machine-learning models trained by the machine-learning training module 250. For example, the data store 260 may store the set of parameters for a trained machine-learning model on one or more non-transitory, computer-readable media. The data store 260 uses computer-readable media to store data, and may use databases to organize the stored data. In some embodiments, the data store 260 includes a plurality of databases. For example, the data store 260 may include a database used for CAD message validation and a separate database for storing event records.

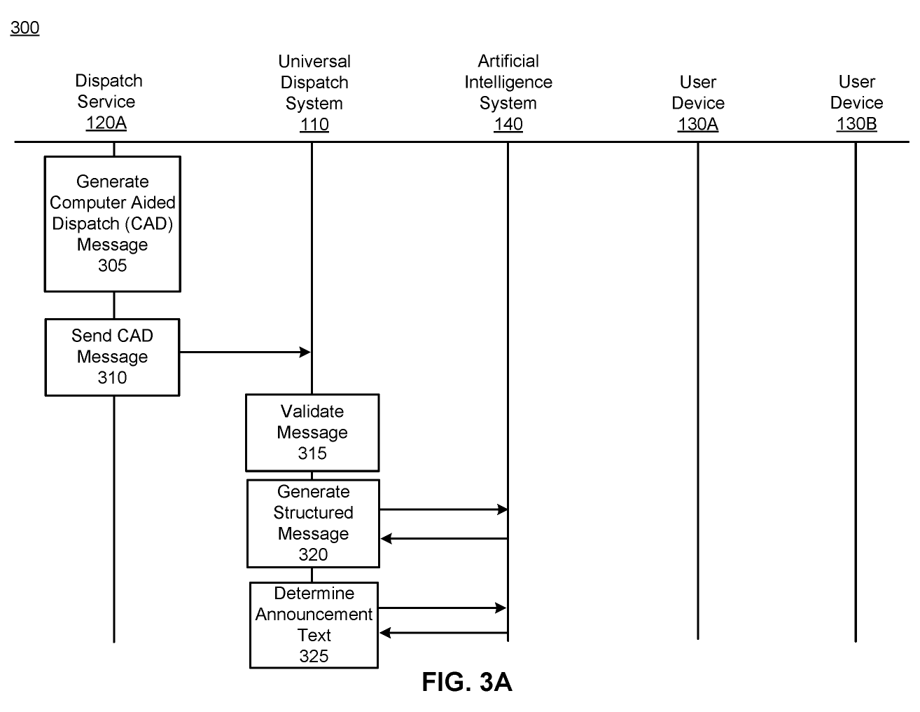

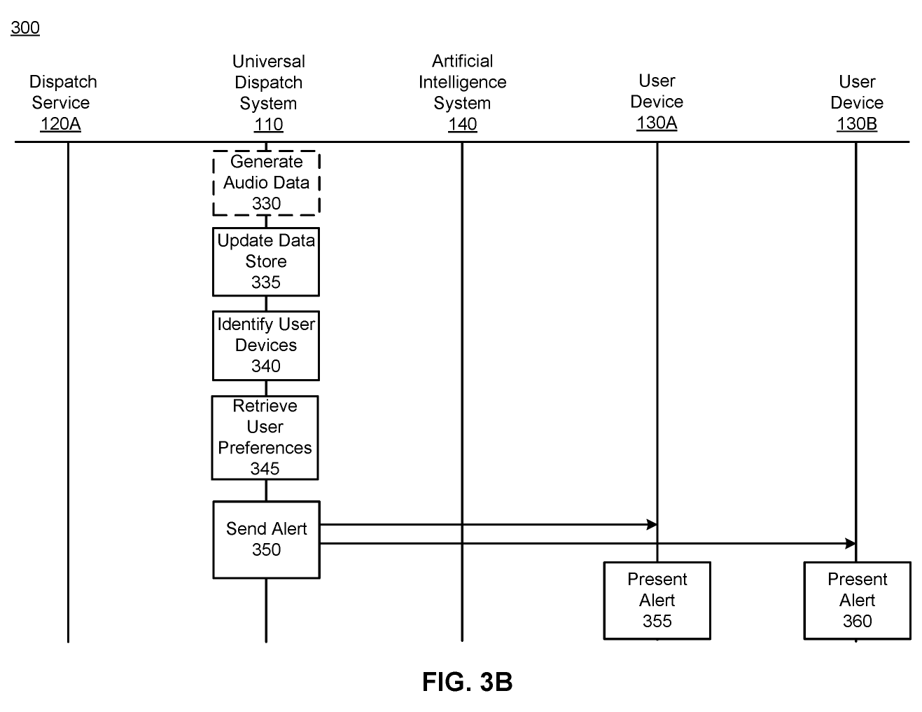

FIGS. 3A-3B form an example sequence diagram 300 that describes leveraging a large language model for universal dispatch messaging, in accordance with some embodiments. Alternative embodiments may include more, fewer, or different interactions from those illustrated in FIGS. 3A-3B, and the steps may be performed in a different order from that illustrated in FIGS. 3A-3B. The sequence diagram 300 describes some actions of the dispatch service 120A, the universal dispatch system 110, the AI system 140, the user device 130A, and the user device 130B. Alternative embodiments may include more, fewer, or different components from those illustrated in FIGS. 3A-3B, and the functionality of each component may be divided between the components differently from the description below. For example, some or all of the functionality of the AI system 140 may be performed by the universal dispatch system 110.

The dispatch service 120A receives a report of an event. For example, a dispatcher of the dispatch service 120A may receive a call reporting an event. The event may relate to, e.g., a medical incident, a crime, etc. The dispatcher may enter details of the event into an interface of the dispatch service 120A. The dispatch service 120A may automatically assign one or more units (e.g., MEDIC1 of Fire Station) of an entity (e.g., Los Angeles County Fire Dept) associated with the dispatch service 120A to respond to the event.

The dispatch service 120A generates 305 a CAD message using the entered details. The CAD message includes at least some of the details entered by the dispatcher, and may also include the assigned one or more units. The dispatch service 120A sends 310 the CAD message to the universal dispatch system 110.

In some embodiments, the dispatch service 120A may also send the CAD message to one or more user devices (e.g., the user device 130A) of the entity that is associated with the dispatch service 120A. Note that the user device 130B is not associated with the entity, as such the dispatch service 120A does not send the CAD message to the user device 130B.

The universal dispatch system 110 validates 315 that the CAD message is authentic (e.g., was actually provided by the dispatch service 120A). For example, the universal dispatch system 110 retrieves an identifier from a data store (e.g., the data store 260). The universal dispatch system 110 may then compare the identifier to a corresponding identifier in the received CAD message. Based on the comparison, the universal dispatch system 110 may determine whether or not that the CAD message is authentic. In some embodiments, where a CAD message fails validation, the universal dispatch system 110 generates a notification. The notification may be sent to an administrator of the universal dispatch system 110, the dispatch service being spoofed, a user device of an entity associated with the dispatch service being spoofed, or some combination thereof.

After the CAD message has been validated, the universal dispatch system 110 generates 320 a structured message using the CAD message. The universal dispatch system 110 generates one or more prompts for application to a large language model. The universal dispatch system 110 prompts the large language model (e.g., of the AI system 140) with the one or more prompts to generate a structured message (e.g., in a JSON format) for the received CAD message. In some embodiments, the one or more prompts may also, e.g., prompt the large language model to generate a title for the structured message and/or determine a priority level of the structured message. In some embodiments, the universal dispatch system 110 may extract a street address from the structured message, convert (e.g., using a third party look up service) the street address to geographic coordinates (e.g., GPS coordinates), and update the structured message with the geographic coordinates.

The universal dispatch system 110 determines 325 announcement text that is based in part on the CAD message. The universal dispatch system 110 may prompt the large language model to generate announcement text based in part on the CAD message, the structured message, or both. For example, the universal dispatch system 110 may prompt the large language model to generate announcement text based on the structured message. Note in the illustrated embodiments step 320 and step 325 occur in a serial manner, but in other embodiments, step 320 and step 325 may occur in parallel.

The universal dispatch system 110 may generate 330 audio data using the announcement text. For example, the universal dispatch system 110 may apply the announcement text to a text-to-speech converter to generate corresponding audio data.

The universal dispatch system 110 updates 335 the data store 260 with an event record. The universal dispatch system 110 may collect the structured message and the announcement text, and may also collect the audio data corresponding to the announcement text, and/or the CAD message. The universal dispatch system 110 may store the collected data as an event record in the data store 260. In some embodiments, the universal dispatch system 110 may determine that the CAD message is an update to a previously received CAD message using an ID value in the structured message. The universal dispatch system 110 may link the event record of the structured message to an event record associated with a structured message generated from the previously received CAD message. The universal dispatch system 110 may update the structured message (and/or a generated alert for the structured message) to show that it is an update to the previous structured message.

The universal dispatch system 110 identifies 340 user devices that are associated with users for alert based in part on content of structured messages. For example, the universal dispatch system 110 may retrieve, from the data store 260, a distribution LUT that maps messages from the dispatch service 120A to a corresponding set of user devices that are part of one or more entities. In the illustrated embodiment, the one or more entities include a first entity that includes the user device 130A, and a second entity that includes the user device 130B. Note that while the first entity is associated with the dispatch service 120A, the second entity is not associated with the dispatch service 120A. The universal dispatch system 110 using the distribution LUT identifies the user device 130A and the user device 130B to receive an alert of the event described by the CAD message.

The universal dispatch system 110 retrieves 345 user preferences for a user of the user device 130A and user preferences for a user of the user device 130B from the data store 260. The user preferences specify, e.g., how (e.g., email, SMS, SNPP, radio, mobile application, etc.) alerts events should be sent to the user device 130B and to the user device 130A. The universal dispatch system 110 generates an alert for each of the user devices based in part on their respective user preferences, and one or more of: the structured message, the announcement text, and the audio data. For example, the user preferences for the user of the user device 130A may indicate alerts be sent via radio, and the user preferences for the user of the user device 130B may indicate that alerts be sent via SMS.

The universal dispatch system 110 sends 350 alerts to the user device 130B and the user device 130A and in accordance with the user preferences. The user device 130A receives its alert, and presents 355 the alert. Likewise, the user device 130B receives its alert and presents 360 the alert.

Note in some embodiments (not shown), the dispatch service 120A may directly send the CAD message to the user device 130A. In these cases, the user preferences may be to not send an alert to the user device 130A, as the user device 130A is part of an entity associated with the dispatch service 120A and is receiving the CAD message directly from the dispatch service 120A.

Note that the user device 130B can receive information about the event from the universal dispatch system 110, even though it is part of an entity that is not associated with the dispatch service 120A. For example, the dispatch service 120A may be for California Fire Department (Cal Fire), and the user device 130B may be associated with a member of a Dallas Fire Department who is deployed to California to help Cal Fire with a wildfire. In the manner described above, both user devices can be notified of events using the universal dispatch system 110. In this manner, the universal dispatch system 110 can facilitate communication of events to user devices of entities that are not associated with a particular dispatch service.

Moreover, the universal dispatch system 110 is able to facilitate generation of standardized structured messages from CAD messages without having to maintain parsers for each possible CAD message format. Not only is this less labor intensive, but it also results in more accurate structured messages when exposed to new formats of a CAD message.

FIG. 4A illustrates an example user interface 400 associated with an entity, in accordance with some embodiments. The user interface 400 is an embodiment of the user interface described above with regard to FIGS. 1, 2, 3A, and 3B. The user interface 400 may be presented on a user device (e.g., the user device 130A). The user interface 400 is a graphical user interface through which a user can interact with the universal dispatch system 110. In the illustrated embodiment, the user interface 400 includes an entity name 405, a section selection area 410, and a content area 415. In other embodiments, the user interface 400 includes different or additional elements. In addition, the functions may be distributed among the elements in a different manner than described.

The entity name 405 identifies an entity of a user accessing the user interface 400. For example, in FIG. 4A, the entity name 405 is "Island County Fire CAD." In the illustrated embodiment, the entity may receive alerts based on CAD messages from dispatch services associated with other entities (i.e., those they do not directly receive CAD messages from), alerts based on CAD messages from dispatch service(s) associated with the entity, or both.

The section selection area 410 presents a plurality of different sections. Each section is associated with different content. In the illustrated embodiment, the plurality of sections includes an overview section, a members section, a training section, and an alerts section. The overview section provides administrator access to various parameters associated with this instance of the entity’s systems. For example, the entity name may be configured in the overview section. The members section provides administrators the ability to provision a distribution LUT that determines which users are to receive notifications for this instance. The training section enables a user to add specific training entries that may be used by the universal dispatch system 110 to generate prompts for the large language model and/or train the large language model. For example, the training section may include an interface that receives, for a training entry, input data and expected output data for the input data. The input data and corresponding expected output data may be used by the universal dispatch system 110 to, e.g., formulate prompts for the large language model, and in some instances train the large language model. In this manner, alerts can be customized to the entity. The alerts section describes alerts that the universal dispatch system 110 provided user devices associated with the entity. Note in other embodiments, the plurality of sections may be different (e.g., no training section). One or more of the plurality of sections may be selectable. A user may select one of the plurality of sections, and the user interface 400 updates the content area 415 to present content associated with the selected section.

The content area 415 presents content associated with a selected section (e.g., selected section 412) of the section selection area 410. In the illustrated embodiment, the selected section 412 is the alerts section and the content area 415 presents alert summaries (e.g., alert summary 420) that have been previously provided to one or more user devices of the entity. Structured messages and their corresponding audio data may be used to generate the alert summaries presented by the user interface 400. Each alert summary is a high level description of a corresponding alert. In the illustrated embodiment, an alert summary associated with an alert includes an icon (e.g., icon 422A), a title (e.g., title 425) of the alert, time information (e.g., time information 430) of the alert, audio playback option (e.g., audio playback option 435) for audio data that corresponds to announcement text for the alert, and a details option (e.g., details option 440).

The icon of an alert summary provides a graphical representation of a type and/or priority level of the alert. For example, icon 422A is for a medical alert, icon 422B is for a fire call, and 422C is for a high priority call (e.g., mass casualty incident). Note in other embodiments, the specific icons used to represent a type and/or priority level of an alert may differ from those illustrated in FIG. 4A.

In some embodiments, an alert summary that was generated based in part on a CAD message from a dispatch service not associated with the entity is flagged in some manner. For example, an icon associated with the alert summary may indicate that it was generated based in part on a CAD message from a dispatch service not associated with the entity. In some embodiments, each CAD message may display an entity name that generated it.

Responsive to selection of a details option of an alert summary associated with an alert, the user interface 400 may present additional details regarding the alert. For example, responsive to a selection of details option 440, the user interface 400 may present additional details of the alert summary 420 (e.g., as shown in FIG. 4B). While the details option in FIG. 4A is a soft button, in other embodiments, it may take some other form. For example, in other embodiments, a title of an alert summary may be a hyperlink that has the functionality of the details option.

FIG. 4B illustrates an example user interface 450 presenting details of an alert, in accordance with some embodiments. The user interface 450 is an embodiment of the user interface 400 post selection of the details option 440 in FIG. 4A. In the illustrated embodiment, the user interface 450 includes a description area 455, a detail area 460, and a CAD message area 465. In other embodiments, the user interface 450 includes different or additional elements. In addition, the functions may be distributed among the elements in a different manner than described.

The description area 455 provides a high level description of the alert. The description area 455 may be populated with information from the corresponding alert summary (e.g., the alert summary 420). For example, in the illustrated example, the description area 455 includes the title 425, the icon 422A, the time information 430, and the audio playback option 435 of the alert summary 420.

The detail area 460 presents details from the structured message used to generate the alert. The details include information from various fields of the structured message. In the illustrated embodiment, the details include an address, a call type, a code, GPS coordinates, an ID (incident number), information about the alert, a unit dispatched to the alert, and WHAT3WORDS coordinates (third party geographic coordinates). In other examples, the details may include different information (e.g., a priority level).

The CAD message area 465 presents the CAD message that was used by the universal dispatch system 110 to generate the structured message and corresponding alert. In the illustrated embodiment, the CAD message area 465 includes an option 470 to provide feedback regarding the alert. In FIG. 4B, the option 470 is a soft button. In other embodiments, the option 470 may be, e.g., a hyperlink. The option 470 may be selected to provide feedback regarding the alert. In some embodiments, responsive to the selection of the option 470, the event record for the alert may be saved as a training example. In some embodiments, responsive to the selection of the option 470, the user interface 450 presents an interface to provide text descriptions and/or ratings of the alert. In this manner, the universal dispatch system 110 may collect feedback from the entities that can be used to, e.g., further refine prompts (e.g., used in generation of structured messages, announcement text, titles, etc.) for the large language model. In some embodiments, the collected feedback may also be used to re-train the large language model.

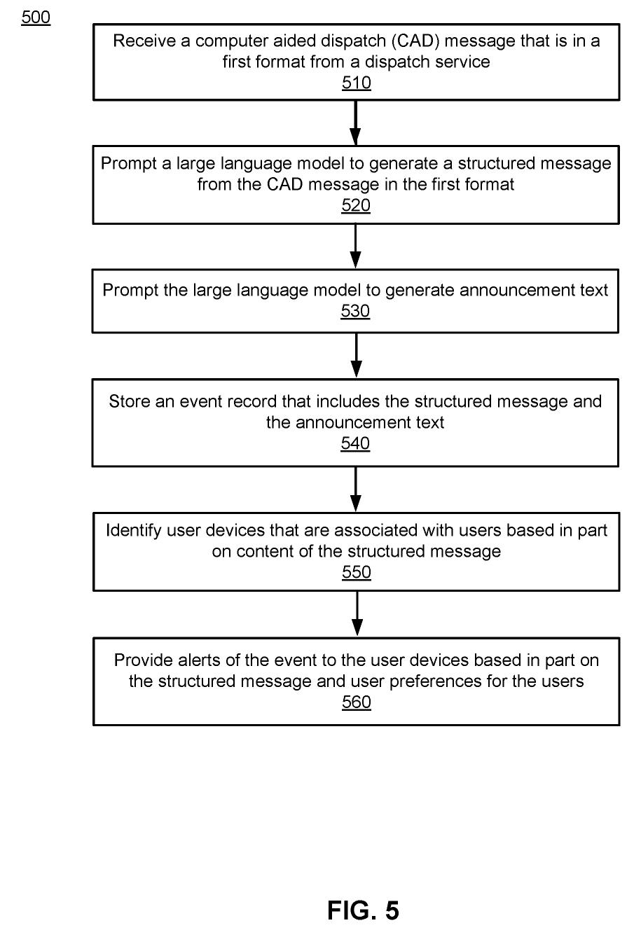

FIG. 5 is a flowchart 500 for a method of leveraging a large language model for universal dispatch messaging, in accordance with some embodiments. Alternative embodiments may include more, fewer, or different steps from those illustrated in FIG. 5, and the steps may be performed in a different order from that illustrated in FIG. 5. These steps may be performed by a universal dispatch system (e.g., universal dispatch system 110). Additionally, each of these steps may be performed automatically by the universal dispatch system without human intervention.

The universal dispatch system receives 510 a CAD message that is in a first format from a dispatch service. The dispatch service is of a plurality of dispatch services, and at least some of the plurality of dispatch services generate CAD messages that are in a format other than the first format. The first format may be, e.g., an unstructured SMS message.

The universal dispatch system prompts 520 a large language model to generate a structured message from the CAD message in the first format. The large language model may be part of an AI system (e.g., the AI system 140) and/or the universal dispatch system. The universal dispatch system generates one or more prompts for application to the large language model. The universal dispatch system prompts the large language model of the AI system with the one or more prompts to generate a structured message (e.g., in a JSON format) for the CAD message. In some embodiments, the one or more prompts may also, e.g., prompt the large language model to generate a title for the structured message and/or determine a priority level of the structured message.

The universal dispatch system prompts 530 the large language model to generate announcement text. The announcement text is based in part on the CAD message. The universal dispatch system may prompt the large language model to generate announcement text based in part on the CAD message, the structured message, or both. Note in the illustrated embodiments step 520 and step 530 occur in a serial manner, but in other embodiments, step 520 and step 530 may occur in parallel. For example, the universal dispatch system may, in parallel, prompt the large language model to generate a structured message from the CAD message, and prompt the large language model to generate announcement text using the CAD message. In some embodiments, the universal dispatch system may generate audio data using the announcement text. For example, the universal dispatch system may apply the announcement text to a text-to-speech converter to generate corresponding audio data.

The universal dispatch system stores 540 an event record that includes the structured message and the announcement text. The universal dispatch system may store the event record in a data store (e.g., the data store 260). In some embodiments, the stored event record includes additional information (e.g., the audio data, the CAD message, etc.).

The universal dispatch system identifies 550 user devices that are associated with users based in part on content of the structured message. For example, the universal dispatch system may use a distribution LUT to identify user devices to provide alerts.

The universal dispatch system provides 560 alerts of the event to the user devices based in part on the structured message and user preferences for the users. The universal dispatch system may retrieve user preferences for the user devices from the data store. The user preferences may identify how (e.g., SMS, email, radio, etc.) to send alerts to the user devices. The universal dispatch system may then provide alerts to each of the user devices in accordance with their user preferences.

FIG. 6 is an example flow 600 for using few-shot training with one or more large language models, in accordance with some embodiments. Alternative embodiments may include more, fewer, or different interactions from those illustrated in FIG. 6, and the steps may be performed in a different order from that illustrated in FIG. 6. These interactions may be performed by a universal dispatch system (e.g., universal dispatch system 110).

A prompt 605 is generated using instructions 610, a CAD message 615 associated with an event, and contextual information 620. The instructions may instruct a large language model to convert the CAD message 615 to a structured message. The instructions 610 may include, e.g., a schema for a format of the structured message (e.g., a schema for JSON). The contextual information 620 provides training examples of CAD messages and their corresponding structured messages. In the illustrated embodiment, the training examples may include one or more general training examples 625, one or more specific training examples 630, or some combination thereof. A general training example includes a CAD message and a structured message that corresponds to the CAD message. A specific training example includes a CAD message and a structured message that corresponds to the CAD message that have been approved for use as a specific example. Note that one or more fields of the structured message of a specific training example may differ from that of a general training example. The approval may be made by, e.g., a user associated with an entity and/or an administrator of the universal dispatch system 110. The one or more specific training examples 630 are a means by which a user associated with an entity can tailor a prompt in order to customize structured messages to have a specific format for the entity.

The prompt 605 is applied to a large language model 635. The large language model 635 may be part of an AI system (e.g., the AI system 140) and/or of the universal dispatch system. Responsive to the prompt 605, the large language model 635 outputs a structured message 640.

In some embodiments, a prompt 645 is generated. In the illustrated embodiment, the prompt 645 is generated using instructions 650, contextual information 655, and the structured message 640. Note in other embodiments, the prompt 645 is generated using instructions 650, the contextual information 655, and the structured message 640 and/or the CAD message 615. The instructions 650 may instruct a large language model to generate announcement text. The contextual information 655 provides training examples of structured messages and their corresponding announcement text.

The prompt 645 is applied to a large language model 660. The large language model 660 may be part of the AI system and/or of the universal dispatch system. In some embodiments, the large language model 635 and the large language model 660 are the same large language model. Responsive to the prompt 645, the large language model 660 outputs announcement text 665. The announcement text 665 is applied to a text-to-speech converter 670 to generate corresponding audio data.

The universal dispatch system may identify user devices to receive alerts. The universal dispatch system may provide alerts of the event to the user devices based in part on the structured message 640 and user preferences of users associated with the user devices. In some embodiments, the alerts use the audio data output from the text-to-speech converter 670.

A user interface 675 may receive feedback 680 from a user associated with an entity whose user devices receive the alerts based in part on the structured message 640. In some embodiments, the feedback may save an event record associated with the structured message 640 as a training example. In some embodiments, the feedback 680 may for example provide feedback regarding specific fields. For example, the feedback 680 may provide feedback regarding a title for the structured message, a priority level of the structured message, etc. In this context a training example is a specific example that may be used to affect how prompts are generated for the large language model 635. In this manner, the user is able to tailor prompts to generate structured messages that are customized to the entity associated with the user. Moreover, using few-shot training techniques to improve the prompt 605 and the prompt 645 helps mitigate having to use large labeled data sets which are conventionally used to train large language models.

### Additional Configuration Information

The described embodiments include various technical improvements in fields such as automated dispatch systems, emergency response communication systems, and optimization of machine learning models such as large language models. For example, the described embodiments enable dispatch and other communications systems to send out electronic notifications with increased accuracy, lower latency, and more custom tailored output digital formats relative to conventional strict parsing approaches or approaches using human intervention. Moreover, the described embodiments enable customized filtering and notification routing due to the use of the structured message that was generated from the CAD message. Such improvements directly relate to the primary purpose of such systems, which is to communicate information to incident response personnel as accurately and quickly as possible.

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method, performed at a computer system comprising a processor and a computer-readable medium, comprising:
receiving, from a dispatch service of a plurality of dispatch services, a computer aided dispatch (CAD) message describing an event and the CAD message is in a first format, where at least some of the plurality of dispatch services generate CAD messages that are in a format other than the first format;
prompting a large language model to generate a structured message from the CAD message in the first format;
prompting the large language model to generate announcement text, wherein the announcement text is based in part on the CAD message;
storing an event record that includes the structured message and the announcement text;
identifying user devices that are associated with users based in part on content of the structured message; and
providing alerts of the event to the user devices based in part on the structured message and user preferences of the users.

2. The method of claim 1, further comprising:
extracting a street address from the structured message;
converting the street address to geographic coordinates; and
updating the structured message with geographic coordinates.

3. The method of claim 1, further comprising:
prompting the large language model to determine a priority level based in part on the structured message; and
updating the structured message with the priority level.

4. The method of claim 1, wherein prompting the large language model to generate the structured message from the CAD message in the first format, further comprises:
prompting the large language model to generate a title for the structured message using the CAD message.

5. The method of claim 1, further comprising:
determining that the CAD message is an update to a previously received CAD message using an identifier in the structured message;
linking the event record to an event record associated with the previously received CAD message; and
prior to providing the alerts of the event to the user devices, updating the alerts to indicate that the structured message is an update to a previous structured message, wherein the previous structured message is associated with the previously received CAD message.

6. The method of claim 1, further comprises:
converting the announcement text to audio data that corresponds to the announcement text,
wherein providing the alerts of the event to the user devices associated with users based in part on the structured message and user preferences for the users, further comprises:
determining a user preference for a user of a user device of the user devices, to have alerts sent to the user device via a wireless broadcast, wherein the audio data is provided to the user device via a wireless broadcast.

7. The method of claim 1, wherein prompting the large language model to generate the announcement text, comprises:
prompting the large language model to generate the announcement text using the structured message.

8. The method of claim 1, wherein prompting the large language model to generate the announcement text, comprises:
prompting the large language model to generate announcement text using the CAD message.

9. The method of claim 8, wherein prompting the large language model to generate announcement text using the CAD message is performed in parallel with prompting the large language model to generate the structured message from the CAD message in the first format.

10. The method of claim 1, further comprising:
providing a user interface to a user device, of the user devices, the user interface presenting one or more alerts that have been provided to the user device;
receiving, from the user device, a selection of an alert of the one or more alerts;
retrieving an event record based in part on the selection; and
presenting based in part on the event record, information from the alert, a CAD message associated with the alert, and an option to provide feedback regarding the alert.

11. The method of claim 1, further comprising:
generating a prompt using the CAD message, instructions to generate the structured message from the CAD message, and contextual information, wherein the contextual information includes at least one specific training example approved by a user associated with a user device of the user devices.

12. The method of claim 1, wherein the dispatch service provides the CAD message to a set of user devices that are associated with users, and providing the alerts of the event to the user devices based in part on the structured message and user preferences of the users comprises:
providing an alert to a user device that is associated with a user who is not one of the users associated with the set of user devices.

13. A computer program product comprising a non-transitory computer readable storage medium having instructions encoded thereon that, when executed by a processor of a computer system, cause the computer system to perform steps comprising:
receiving, from a dispatch service of a plurality of dispatch services, a computer aided dispatch (CAD) message describing an event and the CAD message is in a first format, where at least some of the plurality of dispatch services generate CAD messages that are in a format other than the first format;
prompting a large language model to generate a structured message from the CAD message in the first format;
identifying user devices that are associated with users based in part on content of the structured message; and
providing alerts of the event to the user devices based in part on the structured message and user preferences of the users.

14. The computer program product of claim 13, further comprising encoded instructions that when executed cause the computer system to perform steps comprising:
extracting a street address from the structured message;
converting the street address to geographic coordinates; and
updating the structured message with geographic coordinates.

15. The computer program product of claim 13, further comprising encoded instructions that when executed cause the computer system to perform steps comprising:
prompting the large language model to determine a priority level based in part on the structured message; and
updating the structured message with the priority level,
wherein the encoded instructions for providing the alerts of the event to the user devices based in part on the structured message and the user preferences for the users cause the computer system to perform steps comprising:
providing the alerts of the event to the user devices based in part on the structured message, the user preferences for the users, and the priority level.

16. The computer program product of claim 13, wherein the encoded instructions for prompting the large language model to generate the structured message from the CAD message in the first format cause the computer system to perform steps comprising:
prompting the large language model to generate a title for the structured message using the CAD message.

17. The computer program product of claim 13, further comprising encoded instructions that when executed cause the computer system to perform steps comprising:
prompting the large language model to generate announcement text, wherein the announcement text is based in part on the CAD message; and
converting the announcement text to audio data that corresponds to the announcement text,
wherein the encoded instructions for providing the alerts of the event to the user devices associated with users based in part on the structured message and user preferences for the users cause the computer system to perform steps comprising:
determining a user preference for a user of a user device of the user devices, to have alerts sent to the user device via a wireless broadcast,
wherein the audio data is provided to the user device via a wireless broadcast.

18. The computer program product of claim 17, wherein the encoded instructions for prompting the large language model to generate the announcement text cause the computer system to perform steps comprising:
prompting the large language model to generate the announcement text using the structured message.

19. The computer program product of claim 13, wherein the dispatch service provides the CAD message to a set of user devices that are associated with users, and the encoded instructions for providing the alerts of the event to the user devices based in part on the structured message and user preferences of the users cause the computer system to perform steps comprising:
providing an alert to a user device that is associated with a user who is not one of the users associated with the set of user devices.

20. A computer system comprising:
a processor; and
a non-transitory computer readable storage medium having instructions encoded thereon that, when executed by the processor, cause the computer system to perform steps comprising:
receiving, from a dispatch service of a plurality of dispatch services, a computer aided dispatch (CAD) message describing an event and the CAD message is in a first format, where at least some of the plurality of dispatch services generate CAD messages that are in a format other than the first format,
prompting a large language model to generate a structured message from the CAD message in the first format,
identifying user devices that are associated with users based in part on content of the structured message, and
providing alerts of the event to the user devices based in part on the structured message and user preferences of the users.
